(19) United States
(12) Patent Application Publication
(10) Pub. No.: US 2026/0213096 A1
(43) Pub. Date: Jul. 23, 2026

(54) ACTUATING MECHANISM FOR A POWER CIRCUIT-BREAKER AND POWER CIRCUIT-BREAKER

(71) Applicant: EATON INTELLIGENT POWER LIMITED, Dublin 4 (IE)

(72) Inventors: Maxim EISEMANN, Alfter (DE); Volker HEINS, Rheinbach (DE); Ralph KRIECHEL, Alfter (DE); Richard Ten Voorde, Bornheim (DE); Bogdan ZABROCKI

(21) Appl. No.: 19/503,074

(22) PCT Filed: Jul. 23, 2024
(86) PCT No.: PCT/EP2024/070895

§ 371 Date: Jan. 16, 2026

(30) Foreign Application Priority Data
Jul. 25, 2023 (DE) 10 2023 119 648.0

(51) Int. Cl. H01H 21/24; H01H 9/20

(52) U.S. Cl. CPC H01H 21/24; H01H 9/20

(57) ABSTRACT

Some embodiments are directed toward an actuating mechanism for a power circuit-breaker for opening and closing main contacts of the power circuit-breaker. The actuating mechanism can include an operating gate including a lever element and an operating link fastened to each other, and an auxiliary restoring element that is a part of the operating gate and that is configured for directly mechanically interacting with a restoring interaction element of a tripping mechanism of the power circuit-breaker.

### CROSS-REFERENCE TO RELATED APPLICATIONS

This application is a national phase filing under 35 C.F.R. § 371 of and claims priority to PCT Patent Application No. PCT/EP2024/070895, filed on Jul. 23, 2024, which claims priority to German Patent Application No. 102023119648.0, filed on Jul. 25, 2023, the contents of which are hereby incorporated in their entireties by reference.

### FIELD OF THE DISCLOSURE

Embodiments of the presently disclosed subject matter are related to an actuating mechanism for a power circuit-breaker. Further embodiments are related to a power circuit-breaker, preferably a power circuit-breaker comprising the actuating mechanism.

### BACKGROUND

Power circuit-breakers are widely used in electricity distribution networks for the protection of electrical appliances and installations against damage associated with excess current caused by an overload or short-circuit. Usually, a power circuit-breaker comprises electromagnetic, thermal and/or electronic tripping means that cause an actuating mechanism to open the main contacts of the power circuit-breaker in case of a tripping event which can be, for instance, a current flowing through the main contacts that exceeds a certain predetermined current value. The tripping means can comprise several components that mechanically interact with each other, for instance a magnetic tripping element like a strike armature or a pressure tripping element like a pressure release gate as well as a tripping shaft that cause a locking mechanism to unlock the actuating mechanism so that the main contacts can be opened. Prior art document US 2019/206650 A1 describes a power circuit-breaker with a pressure-tripping unit.

After a tripping event all tripping means components must or should be reset, i.e. moved back into their respective initial positions, which can also be denoted as home positions, in order to set the circuit-breaker into a reset state from which it can be switched on again. In order to achieve a resetting of the tripping means components, usually individual return springs are associated with one or more of the tripping means components, which counteract the tripping movement of the tripping means components and are configured to move the components back to their respective initial position. Thus, the return springs must or should not be too strong, so that the tripping functionality is not hindered. However, it can be possible that, for instance, debris builds up on one or more of the tripping means components, which can cause the return springs to have insufficient force to return the components to their respective initial positions. The use of more and/or stronger return springs, however, could impair the tripping functionality.

At least one object of certain embodiments is to provide an actuating mechanism for a power circuit-breaker. At least one further object of certain embodiments is to provide a power circuit-breaker with the actuating mechanism.

These objects are achieved by the subject-matters according to the independent claims. Advantageous embodiments and developments are characterized in the dependent claims and are disclosed by the following description and the drawings.

According to at least one embodiment, an actuating mechanism for a power circuit-breaker comprises an operating gate. In particular, the actuating mechanism is configured for opening and closing main contacts of the power circuit-breaker. According to a further embodiment, a power circuit-breaker comprises main contacts and the actuating mechanism. The following description equally relates to the actuating mechanism and to the power circuit-breaker with the actuating mechanism.

The power circuit-breaker can be a single-pole power circuit-breaker or a multi-pole power circuit-breaker that comprises, for each pole, main contacts. The actuating mechanism can be configured for opening and closing all of the main contacts during normal operation conditions. In particular, the operating gate of the actuating mechanism can be configured for opening and closing the main contacts. The actuating mechanism and, in particular, the operating gate of the actuating mechanism, has a first switching position in which the main contacts are opened and a second switching position in which the main contacts are closed. In other words, the first switching position is a home position of the actuating mechanism, in which the power circuit-breaker is in an off-state, whereas the power circuit-breaker is in an on-state when the actuating mechanism is in the second switching position. Furthermore, the actuating mechanism and, in particular, the operating gate has a third switching position into which the actuating mechanism can change from the second switching position when a tripping event occurs. In particular, the third switching position can be a position that is situated between the second switching position and the first switching position. In the following, the third switching position is also denoted as tripped position. Here and in the following, a tripping event can be any predetermined event at which the main contacts of the power circuit-breaker should be opened. For instance, as explained above, a tripping event can be an event where a current flows through the main contacts that exceeds a predetermined current value. When in the tripped position, the actuating mechanism usually remains in this state until it is moved back to the first switching position by an operator.

The power circuit-breaker can further comprise a locking mechanism for reversibly locking the actuating mechanism in the second switching position during normal operation. When the operating gate of the actuating mechanism of the power circuit-breaker is moved from the first switching position to the second switching position, for instance by an interaction of an operator with the operating gate, the locking mechanism locks the actuating mechanism, so that the actuating mechanism and, in particular, the operating gate of the actuating mechanism can remain in the second switching state and the main contacts remain closed in the absence of a tripping event and in the absence of high currents that are below the predetermined current value that is defined as a lower limit for a tripping event but that can lead to a short opening of the main contacts due to electromagnetic repulsion. The locking mechanism can be overridden by an operator when pushing the actuating mechanism from the second switching position towards the first switching position, so that the power circuit-breaker can be changed by an operator from the on-state to the off-state. Here and in the following, an “operator” can be a human operator or a so-called remote operator which can be an additional device mounted on the power circuit-breaker.

The actuating mechanism can further comprise at least one spring that is configured for supporting the movement of the operating gate of the actuating mechanism from the second switching position towards the first switching positing. When the locking mechanism is unlocked, for instance by an operator or a tripping mechanism as explained in the following, the at least one spring effects that the actuating mechanism can change from the second switching position to the first switching position or to the tripped position, so that, in both cases, the main contacts are opened.

Furthermore, the power circuit-breaker comprises tripping means configured for unlocking the locking mechanism, so that the main contacts can be opened in case of a tripping event. The tripping means can comprise a tripping mechanism and a tripping unit. The tripping unit can be configured to electronically or physically react to a tripping event and can be, for instance, a pressure tripping unit and/or an electromagnetic tripping unit. The tripping unit can have at least one actuating element that moves in reaction to a tripping event. In other words, the tripping unit transfers a tripping event into a movement of the actuating element. The tripping mechanism can be configured to transfer the movement of the at least one actuating element of the tripping unit to the locking mechanism, so that the tripping-event induced movement of the at least one actuating element results in an unlocking of the locking mechanism and, thus, of the actuating mechanism.

Preferably, the actuating element can be a pivoting gate. Although in the following the actuating element of the tripping unit is mostly explained in connection with a pivoting gate, the actuating element can, for example, also comprise or be a piston or a tappet.

Preferably, the power circuit-breaker can comprise at least one respective actuating element, for instance at least one pivoting gate, for each pole. As described above, the at least one actuating element, for instance the at least one pivoting gate, can be a part of an active or passive monitoring unit that is configured to move the at least one actuating element in case of a tripping event from a home position to a tripping position in case of a tripping event. Preferably, the movement is a pivoting movement.

Furthermore, the at least one actuating element, for instance the at least one pivoting gate, can be configured, when changing into the tripping position, to exert a force on the tripping mechanism that causes the tripping mechanism to unlock the locking mechanism, so that the actuating mechanism can change from the second switching position to the first switching position. In particular, the tripping mechanism can have a tripping position and a home position, wherein the tripping mechanism can be moved from the home position to the tripping position by the at least one pivoting gate. When changing into its tripping position, the tripping mechanism can exert a force on a part of the locking mechanism that causes the locking mechanism to unlock and free the actuating mechanism.

According to a further embodiment, the tripping mechanism comprises a tripping bridge with a tripping rod that can mechanically interact with the at least one actuating element, for instance the at least one pivoting gate. Furthermore, the tripping mechanism can comprise one of more return springs that are configured to return the tripping mechanism, in particular the tripping bridge, into the home position after a tripping event. In this case, it can be possible that by means of the tripping rod also the at least one actuating element, for instance the at least one pivoting gate, can be returned to its home position.

According to a further embodiment, the actuating mechanism comprises an auxiliary restoring element that can interact with the tripping mechanism. In particular, the auxiliary restoring element can be configured to support the returning of the tripping mechanism and the at least one actuating element to their respective home position. Thus, under certain conditions as explained in the following, the auxiliary restoring element can exert an additional force directly to the tripping mechanism and indirectly, via the tripping mechanism, to the at least one actuating element for moving the tripping mechanism and the at least one actuating element to their respective home positions. Furthermore, the tripping mechanism and, particularly, the tripping bridge can comprise a restoring interaction element, wherein the auxiliary restoring element is configured for directly mechanically interacting with a restoring interaction element. Preferably, the auxiliary restoring element is configured for directly mechanically interacting with the restoring interaction element when, after the actuating mechanism has changed from the second switching position into the tripped position due to a tripping event, the actuating mechanism is changed from the tripped position to the first switching position. In particular, the interaction between the auxiliary restoring element and the restoring interaction element can be or comprise a pushing interaction. In other words, the auxiliary restoring element can be configured for pushing the restoring interaction element, so that, when the actuating mechanism is pushed from the tripped position towards the first switching position by an operator, the tripping mechanism can be pushed by the actuating mechanism towards its home position. According to certain embodiments, the auxiliary restoring element is configured such that the auxiliary restoring element can directly mechanically interact with the tripping mechanism only after a tripping event when the actuating mechanism is returned by an operator from the tripped position to the first switching position.

Preferably, the auxiliary restoring element and the restoring interaction element can be configured such that, in the absence of a tripping event, the auxiliary restoring element of the actuating mechanism and the restoring interaction element of the tripping mechanism have no mechanical contact or only a weak mechanical contact when the actuating mechanism is in the first switching position. A weak mechanical contact can for instance mean that the auxiliary restoring element and the restoring interaction element barely touch each other and/or that no significant force is exerted by the auxiliary restoring element to the restoring interaction element. When the actuating mechanism changes from the first switching position to the second switching position, the auxiliary restoring element is moved away from the restoring interaction element, so that, when the actuating mechanism is in the second switching position, there is preferably no mechanical contact between the auxiliary restoring element and the restoring interaction element.

As explained above, the auxiliary restoring element can be configured such that, after a tripping event, during at least a part of the operator-induced change of the actuating mechanism from the tripped position to the first switching position, the auxiliary restoring element pushes against the restoring interaction element. Consequently, the auxiliary restoring element can exert a force on the tripping mechanism that supports moving the tripping mechanism from the tripping position to its home position. In this case, the tripping mechanism can be configured to exert a force on the at least one actuating element towards the home position of the at least one actuating element. Thus, the actuating mechanism with the auxiliary restoring element can support pushing the at least one actuating element of the tripping unit to its home position after a tripping event. Consequently, the auxiliary restoring element can assist the action of return springs as explained above, so that it can be possible that the tripping mechanism and the tripping unit with the at least one actuating element can be reset to their respective home position even in case that the at least one pivoting gate is slightly blocked, for instance by debris, so that the strength of the one or more return springs would not be sufficient.

In case of a heavy fault event in which for instance the actuating element is heavily blocked, for instance jammed, in the tripping state, so that even the additional force exerted by the auxiliary restoring element is not sufficient to restore the home position, the auxiliary restoring element of the actuating mechanism and the restoring interaction element of the tripping mechanism can be configured to be in mechanical contact when the actuating mechanism is in the first switching position. Preferably, the auxiliary restoring element is at least partly elastic so that the auxiliary restoring element can be deformed and the actuating mechanism can fully return into the first switching position.

According to a further embodiment, the operating gate of the actuating mechanism comprises a lever element and an operating link. The lever element and the operating link can be fastened to each other, for instance by a screw fastening or a rivet fastening including one or two or more screws or rivets. The lever element can be made of a plastic material and, for instance, can comprise a handle, configured for interaction with an operator, and a plate element in direct mechanical contact to the operating link. The plate element can be plane or can have a curvature. The auxiliary restoring element is a part of the operating gate and is fixedly connected to the operating link. For instance, the auxiliary restoring element can comprise or be an elongated part that extends away from operating link. In particular, the elongated part can be that part of the auxiliary restoring element that can mechanically interact with the restoring interaction element of the tripping mechanism. According to a further embodiment, the auxiliary restoring element is an integral part of the lever element. For instance, the auxiliary restoring element can be a nose-shaped extension of the lever element. For instance, in case the lever element comprises a handle configured for interaction with an operator and a plate element in direct mechanical contact to the operating link, the auxiliary restoring element can be an integral part of the plate element. In other words, the plate element can have a nose-shaped extension.

According to a further embodiment, the auxiliary restoring element is a component that, in addition to the lever element, is fastened to the operating link. In particular, the auxiliary restoring element can be fastened to the operating link by means of the same fastening means as the lever element, i.e. by one or more screws or rivets. Preferably, the auxiliary restoring element and the lever element can together be fastened to the operating link by the same screws or rivets. Thus, the lever element and the auxiliary restoring element can together be fixedly connected to the operating link by means of a screw fastening or rivet fastening.

According to a further embodiment, the auxiliary restoring element is a flat spring fixedly connected to the operating link. Thus, the auxiliary restoring element can be made from spring steel and can be formed as or comprise a sheet-like strip made from spring steel. The flat spring can have a mounting section that is fastened to the operating link, for instances by one or more screws or rivets, and a cantilever section that extends from the mounting section. In particular, at least the cantilever section of the flat spring can be formed as a sheet-like strip.

According to a further embodiment, the auxiliary restoring element has a contact surface that is configured to directly mechanically interact with an interaction surface of the restoring interaction element. In particular, when interacting the contact surface can push against the interaction surface. Preferably, the auxiliary restoring element is configured such that, after a tripping event, during at least a part of the operator-induced change of the actuating mechanism from the tripped position to the first switching position, the contact surface can slide over the interaction surface while at the same time pushing against the interaction surface. This can lower the momentum and force impact of the auxiliary restoring element on the restoring interaction element when interacting with the tripping mechanism.

The cantilever section of the flat spring can have a contact section. The cantilever section can further have a connection section arranged between the contact section and the mounting section. The contact section can be configured for mechanically interacting with the restoring interaction element of the tripping mechanism. The flat spring as a whole or at least the cantilever section can be plane or can comprise one or more bent sections. Preferably, the contact section can have at least a first bent section adjacent the connection section. In other words, the cantilever section can have a bent shape at a transition from the connecting section to the contact section. Furthermore, the contact section can have a second bent section remote from the first bent section. The second bent section can form an end region of the cantilever section at an end of the auxiliary restoring element remote from the operating link. Furthermore, the whole contact section can be a bent section. Moreover, the contact section can have a width that at least partly decreases with increasing distance from the connection section. In other words, the contact region can become narrower towards the end of the auxiliary restoring element that is remote from the operating link.

As described above, after a tripping event of the circuit-breaker, by means of the tripping unit, for instance a magnetic tripping unit or a pressure tripping unit, all tripping means components, i.e. all components associated with the tripping functionality like the components of the tripping mechanism and of the tripping unit must or should be safely brought back into their initial positions in order to enable the power circuit-breaker to be switched on again. In order to achieve this goal, the actuating mechanism comprises the auxiliary restoring element that is a firmly attached part of the operating gate. During the power circuit-breaker switch-on process, after leaving the off position, i.e. the first switching position, the auxiliary restoring element is ineffective. However, during each power circuit-breaker switch-off process, the auxiliary restoring element can exert a predetermined small force on the tripping bridge of the tripping mechanism and, thus, also on the at least one actuating element of the tripping unit in order to bring the components into their respective home position.

The auxiliary restoring element, for instance formed by the flat spring, is dimensioned and configured such that in the event of a malfunction a correct indication of the tripping means components is always in this particular embodiment be ensured. If the tripping means components remain in a position other than their home position, the movement of the flat spring is absorbed in deformation of the spring without moving the tripping means components, so that the tripping means components remain in a “fault” message status. Switching on of the circuit-breaker is then safely prevented. Consequently, preferably the main task of the auxiliary restoring element is to support a move of the tripping means components to their respective home positions at each switch-off without influencing the tripping functionality after a switch-on.

### BRIEF DESCRIPTION OF FIGURES

Further features, advantages and expediencies will become apparent from the following description of exemplary embodiments in conjunction with the figures.

FIGS. 1A to 1E show various schematic illustrations of a power circuit-breaker according to an embodiment,

FIGS. 2A to 2D show schematic illustrations of the operating gate of the actuating mechanism of the power circuit-breaker of the embodiment of FIGS. 1A to 1E,

FIGS. 3 to 8 show schematic illustrations of various states of the power circuit-breaker of the embodiment of FIGS. 1A to 1E,

FIG. 9 shows a schematic illustration of an auxiliary restoring element according to a further embodiment,

FIG. 10 shows a schematic illustration of a lever element according to a further embodiment.

### DETAILED DESCRIPTION

In the figures, elements of the same design and/or function are identified by the same reference numerals. It is to be understood that the embodiments shown in the figures are illustrative representations and are not necessarily drawn to scale.

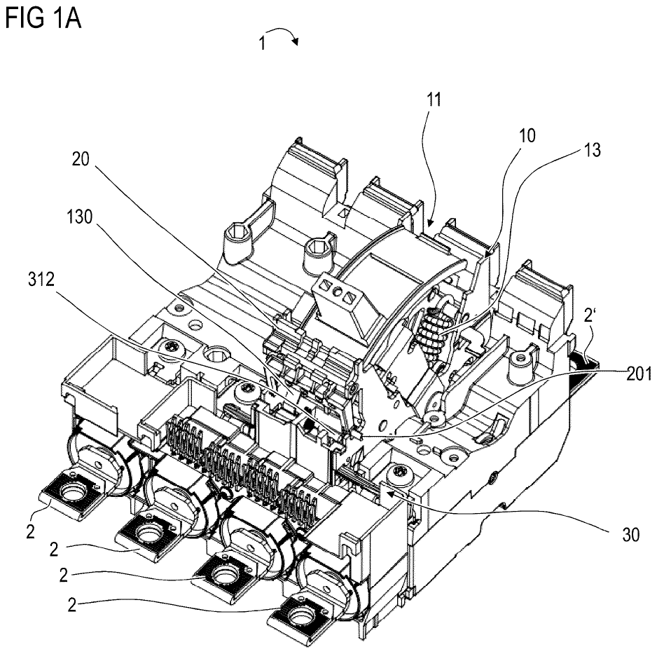

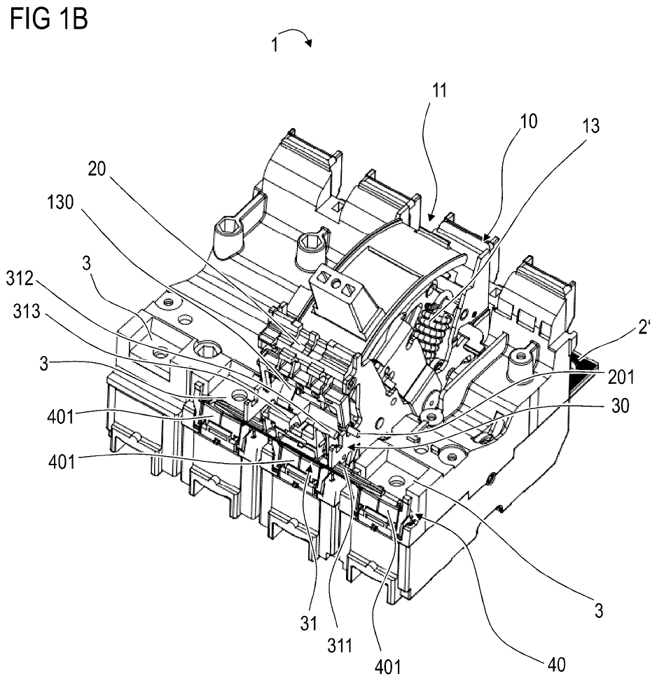

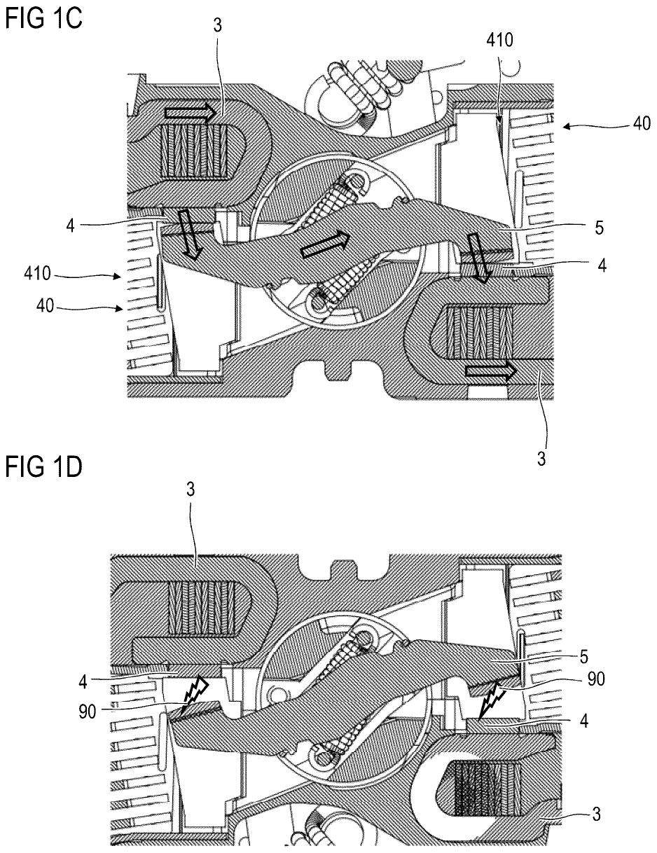

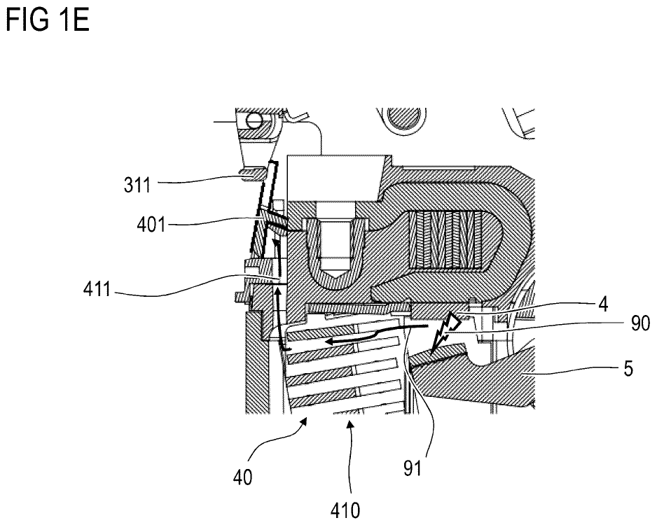

FIGS. 1A to 1E show schematic three-dimensional illustrations and sectional illustrations of a power circuit-breaker 1 according to an embodiment, wherein in FIG. 1B the main terminals 2 that are shown in FIG. 1A on the front side are not shown. FIGS. 1C to 1E shown sectional views of the interior of the power circuit-breaker 1.

By way of example, the power circuit-breaker 1 is embodied as a four-pole power circuit-breaker, wherein each pole comprises a pair of external main terminals 2, 2′, i.e. an external main terminal 2 on the front side and an external main terminal 2′ on the back side in the illustration shown in FIG. 1A. Each of the four pairs of main terminals 2, 2′ can be connected to the three phases and a neutral line of an electric grid. Alternatively to the four-pole design shown in FIGS. 1A and 1B, the power circuit-breaker can have any other number of poles.

Each external main terminal 2, 2′ is connected via a respective busbar 3 to a main contact 4 inside the power circuit-breaker 1. By means of a contact bridge 5, each pair of main contacts 4 and, thus, each pair of main terminals 2, 2′ can be closed, i.e. connected to each other as shown in FIG. 1C for one pole, and opened, i.e. disconnected from each other. The arrows in FIG. 1C show an exemplary current flow.

The power circuit-breaker 1 further comprises an actuating mechanism 10 configured for opening and closing all of the main contacts 4 during normal operation conditions. In particular, the actuating mechanism 10 comprises an operating gate 11 that is configured for opening and closing the main contacts 4. The actuating mechanism 10 and, thus, the operating gate 11, has a first switching position in which the main contacts 4 are opened, which is the off-state of the power circuit-breaker, and a second switching position in which the main contacts 4 are closed, which is the on-state of the power circuit-breaker. In FIGS. 1A and 1B the first switching position is shown, which is a home position of the actuating mechanism 10 and in which the power circuit-breaker 1 is in the off-state. The switching state shown in FIG. 1C corresponds to the second switching position of the actuating mechanism 10 and the operating gate 11, where the power circuit-breaker 1 is in the on-state. Furthermore, the actuating mechanism 10 and, in particular, the operating gate 11 has a tripped position as a third switching position into which the actuating mechanism 10 can change from the second switching position when a tripping event occurs as explained in detail below. In particular, the tripped position is a position that is situated between the second switching position and the first switching position. When in the tripped position, the actuating mechanism 10 usually remains in this state until it is moved back to the first switching position by an operator pushing the actuating mechanism 10 towards the first switching position.

The power circuit-breaker 1 further comprises a locking mechanism 20 for reversibly locking the actuating mechanism 10 in the second switching position. When the operating gate 11 of the actuating mechanism 10 is moved from the first switching position to the second switching position, for instance by an interaction of an operator with the operating gate 11, the locking mechanism 20 locks the actuating mechanism 10, so that the actuating mechanism 10 and, in particular, the operating gate 11 of the actuating mechanism 10 can temporarily remain in the second switching state in which the main contacts 4 are closed. The actuating mechanism 10 further comprises at least one spring 13 that is configured for moving the operating gate 11 of the actuating mechanism 10 from the second switching position to the tripped position or to the first switching positing when the locking mechanism 20 is unlocked, thereby opening the main contacts 4.

In order to protect an installation in an electricity distribution network, which is arranged down-circuit of the power circuit-breaker 1, against an overload and/or short-circuit currents, the power circuit-breaker 1 is equipped with tripping means configured for unlocking the locking mechanism 20. Consequently, the main contacts 4 can be opened in case of a tripping event that can be, as explained in the general part, a current that flows through the main contacts 4 that exceeds a predetermined current value.

The tripping means comprise a tripping mechanism 30 and a tripping unit 40 with at least one actuating element 401 that is moved in case a tripping event occurs. In the embodiment shown, the at least one actuating element 401 is a pivoting gate, so that in the following description the reference numeral 401 will be used also in connection with the pivoting gate. However, the at least one actuating element 401 is not limited to a pivoting gate.

Alternatively, the actuating element 401 can, for example, also comprise or be a piston or a tappet.

As shown in FIG. 1B, the power circuit-breaker 1 comprises a respective pivoting gate 401 for each pole. The pivoting gates 401 can be formed of a plastic. The pivoting gates 401 are parts of the tripping unit 40 formed by an active or passive monitoring unit that is configured to move the at least one pivoting gate 401 in case of a tripping event. In the embodiment shown, the pivoting gates 401 are parts of a pressure tripping unit. Alternatively or additionally, the power circuit-breaker 1 can also comprise an electromagnetic tripping unit that, for instance, can, in the event of a tripping event, cause the excitation of a trip magnet that can be configured to move the actuating element 401. However, by way of example only, the following description refers to a pressure tripping unit.

The mode of operation of the pressure tripping unit is depicted in FIGS. 1D and 1C. The pressure tripping unit comprises an arc chute 410 next to the main contacts 4. In the event of very high currents, the electromagnetic effects of the currents flowing in the main contacts 4 are so great that the main contacts 4 of the power circuit-breaker, as a result of electromagnetic repulsion between the main contacts 4 and the contact bridge 5, are subject to short-term mutual disengagement from the contact bridge 5. This results in the generation of an arc 90 between the main contacts 4 and the contact bridge 5, which is indicated in FIG. 1D. As shown in FIG. 1E, the arc generation causes an overpressure, indicated by arrows 91, in the arc chute 7 that can propagate through a channel 411 directly in the direction of the pivoting gate 401. Since the at least one actuating element 401 is configured as a pivoting gate, it can pivot about a pivoting axis between a home position, depicted in FIG. 1B and a tripping position, depicted in FIG. 1E. The overpressure 91 is applied to the pivoting gate 401 which, provided that a predetermined pressure threshold value is exceeded, executes a transition by a rotary motion from the home position to the tripping position. In the tripping position, the pivoting gate 401 can, for instance, cooperate with a section of the busbar or with another part or component that forms a mechanical stop for the motion of the pivoting gate 401. Setting of the pressure threshold value can be achieved, for instance, by means of a suitable return spring that engages on the pivoting gate 401 and/or on the tripping mechanism 30.

Furthermore, the at least one pivoting gate 401 is configured, when changing into the tripping position, to exert a force on the tripping mechanism 30 that causes the tripping mechanism 30 to unlock the locking mechanism 20, so that the actuating mechanism 10 can change from the second switching position to the tripped position. In particular, the tripping mechanism 30 can have a tripping position and a home position, wherein the tripping mechanism 30 can be moved from the home position to the tripping position by the tripping unit 40, in particular by the at least one pivoting gate 401. When changing into its tripping position, the tripping mechanism 30 can exert a force on a part of the locking mechanism 20 that causes the locking mechanism 20 to unlock and free the actuating mechanism 10.

As can be seen in FIG. 1B, the tripping mechanism 30 comprises a tripping bridge 31 with a tripping rod 311 that can mechanically interact with the at least one pivoting gate 401. Furthermore, the tripping mechanism 30 comprises a tripping lever 312 that can mechanically interact with a locking mechanism lever 201 of the locking mechanism 20. In particular, the tripping lever 312 can, when the tripping mechanism 30 is moving into its tripping position, push the locking mechanism lever 201 and cause the locking mechanism 20 to unlock.

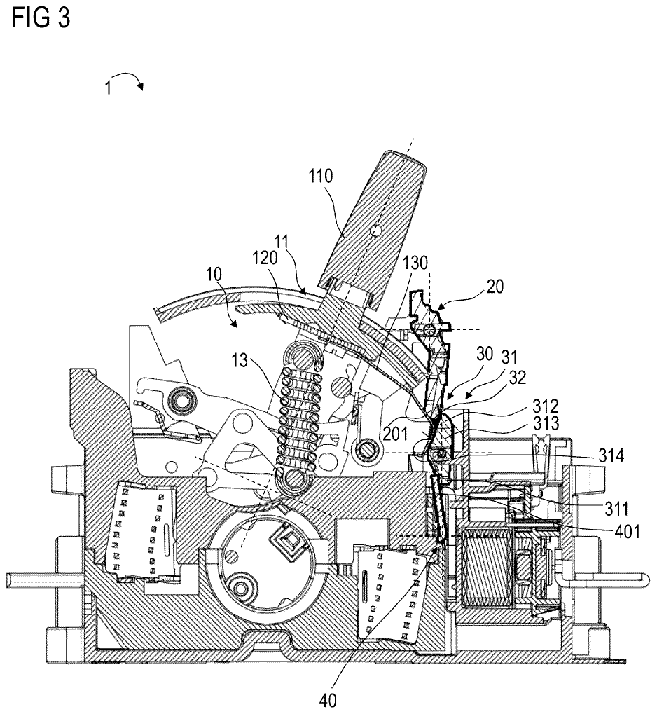

The tripping mechanism 30 can comprise one of more return springs that can be seen for example in FIGS. 3 to 6 explained below and that are configured to return the tripping mechanism 30, in particular, the tripping bridge 31, into the home position after a tripping event. In this case, it can be possible that by means of the tripping rod 311 also the pivoting gates 401 can be returned to their home positions that is shown in FIG. 1B.

In order to support the restoring of the home positions of the pivoting gates 401 and the tripping mechanism 30, the actuating mechanism 10 comprises an auxiliary restoring element 130 that can interact with the tripping mechanism 30. In particular, the auxiliary restoring element 130 is a part of the operating gate 11 of the actuating mechanism 10 and is configured to support the returning of the tripping mechanism 30 and the pivoting gates 401 to their respective home positions. In particular, under certain conditions as explained in the following, the auxiliary restoring element 130 can exert an additional force directly to the tripping mechanism 30 and indirectly, via the tripping mechanism 30, to the pivoting gates 401 for moving the tripping mechanism 30 and the pivoting gates 401 to their respective home positions.

The tripping mechanism 30 and, particularly, the tripping bridge 31 comprises a restoring interaction element 313, wherein the auxiliary restoring element 130 is configured for directly mechanically interacting with a restoring interaction element 313. Preferably, the auxiliary restoring element 130 is configured for directly mechanically interacting with the restoring interaction element 313 when, after a tripping event and after having changed into the tripped position, the actuating mechanism 10 changes from the tripped position to the first switching position due to an interaction of an operator with the actuating mechanism 10. In particular, the interaction between the auxiliary restoring element 130 and the restoring interaction element 313 is a pushing interaction. In other words, the auxiliary restoring element 130 is configured for pushing the restoring interaction element 313, so that, when the actuating mechanism 10 is pushed from the tripped state towards the first switching position, the tripping mechanism 30 can be pushed by the actuating mechanism 10 towards its home position.

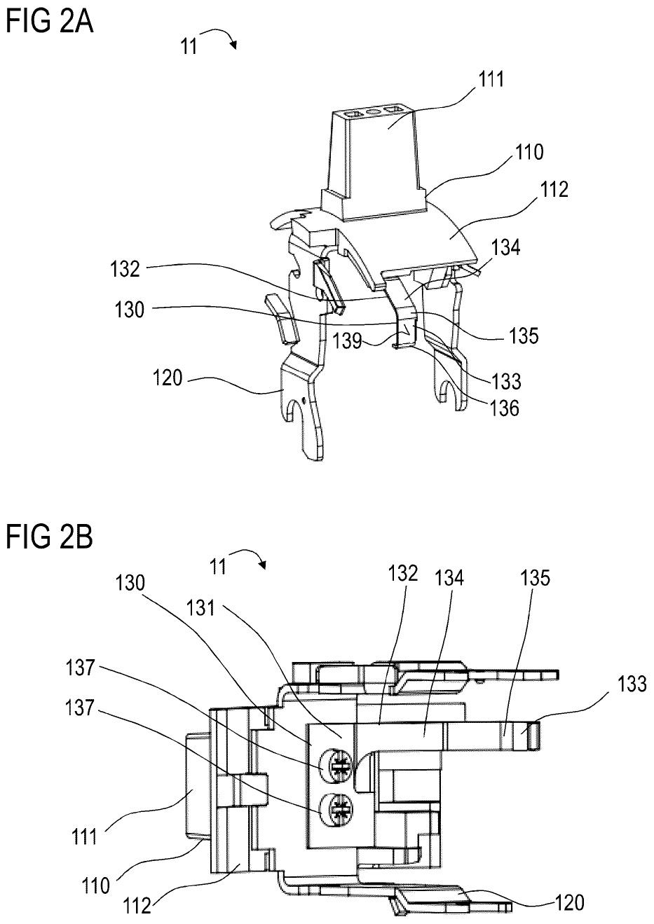

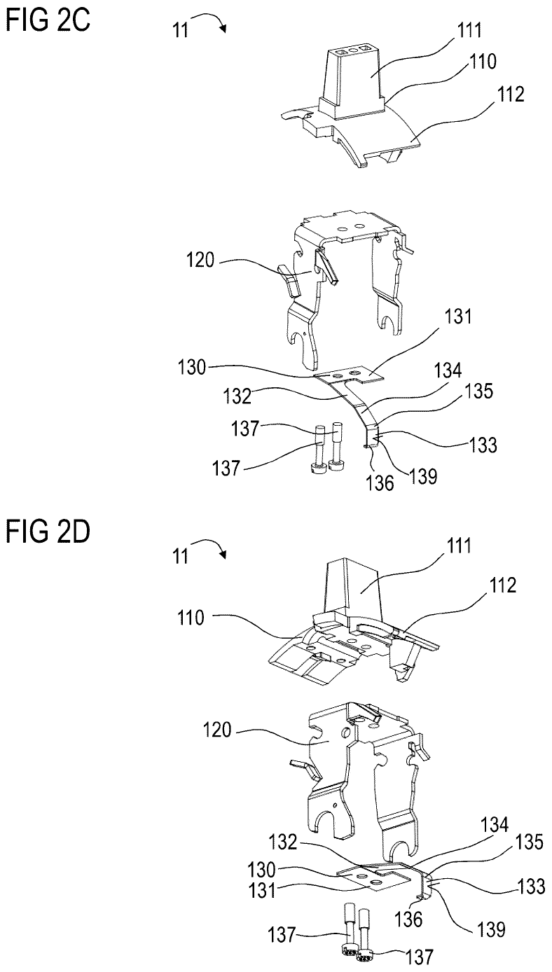

FIGS. 2A to 2D shows several schematic illustration of the operating gate 11 according to an embodiment, wherein FIGS. 2A and 2B show three-dimensional illustrations of the assembled operating gate 11 and FIGS. 2C and 2D show three-dimensional exploded views of the operating gate 11 from different viewing angles, respectively.

The operating gate 11 comprises a lever element 110 and an operating link 120. The lever element 110 and the operating link 120 are fastened to each other, for instance by a screw fastening using one or more screws 137. As shown in FIGS. 2A to 2D, for instance two screws 137 can be used. Alternatively, a rivet fastening including one or two or more rivets could be used. The lever element 110 can be made of a plastic material and can comprise a handle 111 configured for interaction with an operator and a plate element 112 in direct mechanical contact to the operating link 120. The plate element 112 can be plane or can have a curvature as indicated in the figures.

The auxiliary restoring element 130 is a part of the operating gate 11 and is fixedly connected to the operating link 120. In particular, the auxiliary restoring element 130 can comprise or be an elongated part that extends away from operating link 120. Preferably, the elongated part can be that part of the auxiliary restoring element 130 that can mechanically interact with the restoring interaction element of the tripping mechanism.

In the embodiment shown, the auxiliary restoring element 130 is a component that, in addition to the lever element 110, is fastened to the operating link 120. In particular, the auxiliary restoring element 130 is fastened to the operating link 120 by means of the same fastening means as the lever element 110, i.e. by the same two screws 137 in the embodiment shown, so that the lever element 110 and the auxiliary restoring element 130 together are fixedly connected to the operating link 120.

The auxiliary restoring element 130 is formed by a flat spring and is made from spring steel. The flat spring is formed by a sheet-like strip of spring steel and comprises a mounting section 131 that is fastened to the operating link 120 and a cantilever section 132 that extends from the mounting section 131 and that forms the elongated part described above.

The cantilever section 132 of the flat spring has a contact section 133 with a contact surface 139, and a connection section 134 between the contact section 133 and the mounting section 131. The contact section 133 and, in particular, the contact surface 139 are configured for mechanically interacting with the restoring interaction element of the tripping mechanism, in particular with an interaction surface of the restoring interaction element.

The flat spring as a whole can be plane. Preferably, as shown in the figures, the cantilever section 132 comprises one or more bent sections 135, 136. Preferably, the contact section 133 can have at least a first bent section 135 adjacent the connection section 134, so that the cantilever section 132 can have a bent shape at a transition from the connecting section 134 to the contact section 133. Furthermore, the contact section 133 has a second bent section 136 remote from the first bent section 135. The second bent section 136 forms an end region of the cantilever section 132 at an end of the auxiliary restoring element 130 remote from the operating link 120. Furthermore, the whole contact section 133 can be a bent section. Moreover, as can be seen in FIGS. 2C and 2D, the connecting section 134 can have a bent section.

FIG. 3 shows a sectional view of the power circuit-breaker 1 in the off-state, i.e. when the actuating mechanism 10 and, in particular, the operating gate 11 are in the first switching position. Due to the sectional view, only one pivoting gate 401 is visible. The tripping mechanism 30 and the pivoting gates 401 of the tripping unit 40 are in their respective home positions. Also visible in FIG. 3 is the above-mentioned return spring 312 of the tripping mechanism 30. The dashed crosses indicate the pivot points of the operating gate 11, the locking mechanism 20, the tripping mechanism 30 and the pivoting gates 40.

The auxiliary restoring element 130 and the restoring interaction element 313 can be configured such that, in the absence of a tripping event, the auxiliary restoring element 130 and the restoring interaction element 313 have no mechanical contact or only a weak mechanical contact when the actuating mechanism 10 is in the first switching position. A weak mechanical contact can for instance mean that the auxiliary restoring element 130 and the restoring interaction element 313 barely touch each other and/or that no significant force is exerted by the auxiliary restoring element 130 to the restoring interaction element 313. When the actuating mechanism 10 changes from the first switching position to the second switching position, which corresponds to a counterclockwise rotation of the operating gate 11, the auxiliary restoring element 130 is moved away from the restoring interaction element 313, so that, when the actuating mechanism 10 is in the second switching position, there is no mechanical contact between the auxiliary restoring element 130 and the restoring interaction element 313.

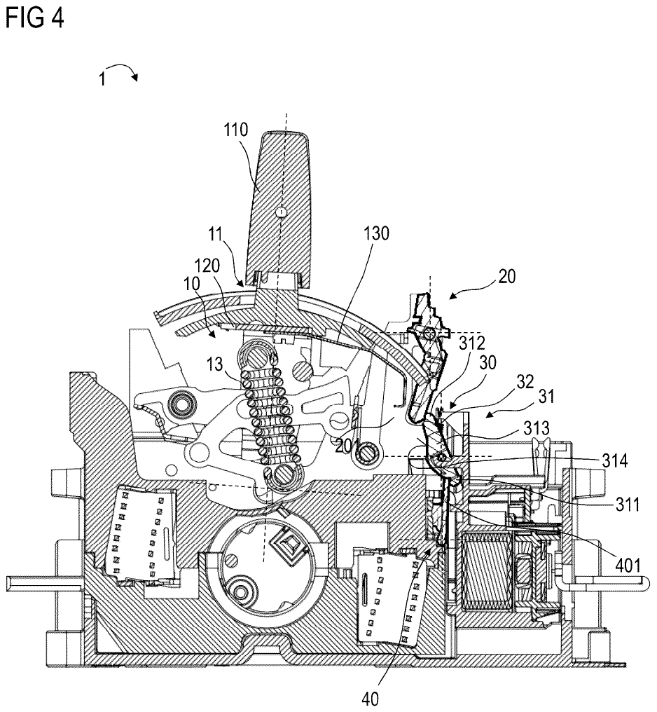

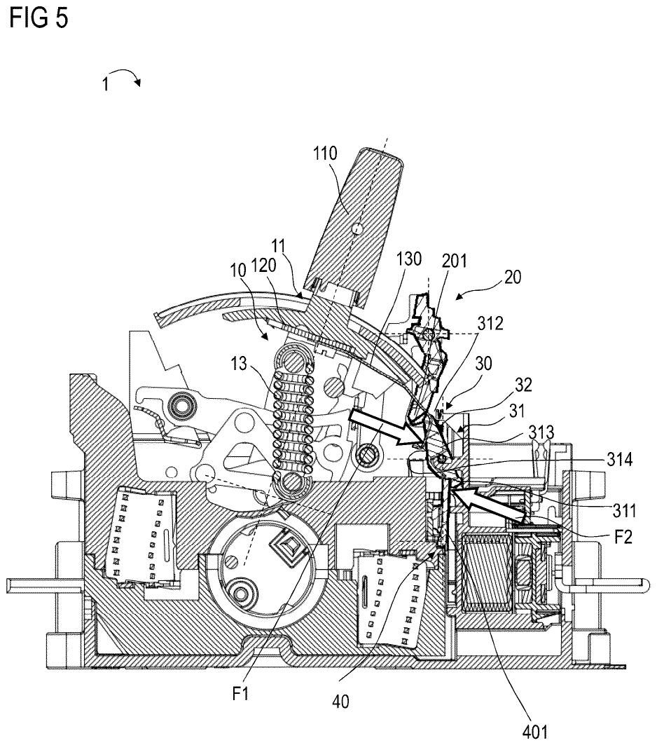

FIG. 4 shows, in a similar sectional view as FIG. 3, the power circuit-breaker 1 in the tripped state, i.e. when the actuating mechanism 10 and, in particular, the operating gate 11 are in the tripped position, after a tripping event has occurred as described in connection with FIGS. 1D and 1E. As explained above, at least one of the pivoting gates 401 is in its tripping position after having rotated around its pivoting point until the pivoting gate 401 reaches a mechanical stop. Depending on the number of poles at which the tripping event occurs, one or more or all of the pivoting gates 401 can be rotated. In the shown view, the movement of the pivoting gate 401 into its tripping position is a clockwise rotation. This rotation causes a simultaneous counterclockwise rotation of the tripping bridge 31 of the tripping mechanism 30 into its shown tripping position, since the at least one pivoting gate 401 pushes against the tripping rod 311 of the tripping bridge 31 during its rotation. Due to the movement of the tripping bridge 31 and the interaction of the tripping lever 312 with the locking mechanism lever 201 the locking mechanism 20 is simultaneously moved into an unlocked state. From this moment on the actuating mechanism 10 is not locked anymore in the second switching position, but moves towards the tripped position. In particular, the return spring 13 of the actuating mechanism effects 10 a clockwise rotation of the operating gate 11. When the actuating mechanism 10 is in the tripped state, the locking mechanism 20 usually stays in a state between its locked-state and its home position.

FIG. 5 shows the power circuit-breaker 1 in the moment when, due to an interaction of an operator with the actuating mechanism 10 that is a pushing action moving the actuating mechanism 10 towards the first switching position, the auxiliary restoring element 130 touches the restoring interaction element 313 of the tripping mechanism 30, thereby starting the direct mechanical interaction between the auxiliary restoring element 130 and the restoring interaction element 313. The auxiliary restoring element 130 pushes against the restoring interaction element 313 with a first force F1 and effects a clockwise rotation of the tripping bridge 31 toward the home position of the tripping mechanism 30. The tripping bridge 31, in turn, pushes with a second force F2 against the at least one pivoting gate 401 in the tripping position, thereby effecting a counterclockwise rotation of the at least one pivoting gate 401 toward its home position. The locking mechanism 20 can be reset to its home position by an associated return spring (not visible in the depicted view).

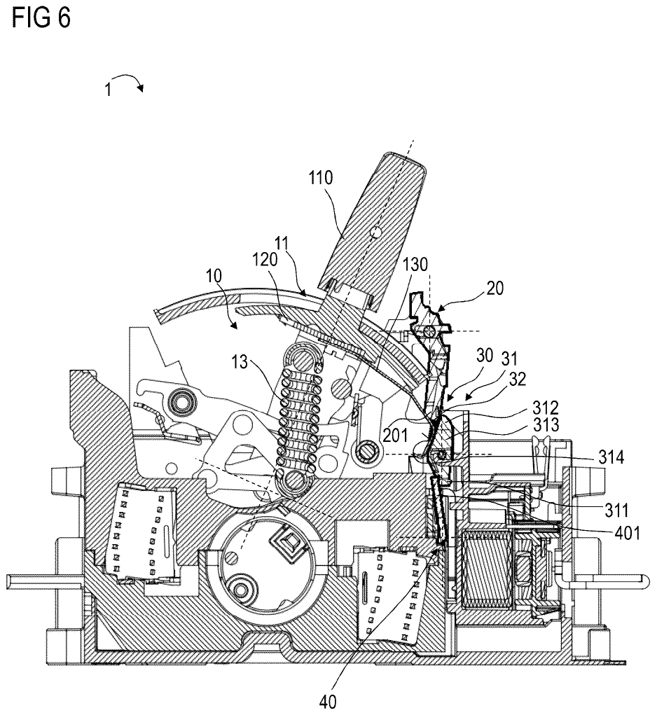

FIG. 6 shows the power circuit-breaker 1 again in the off-state as explained in connection with FIG. 3. The home position of the tripping mechanism 30 can be defined by a mechanical stop, for instance formed by a part of the housing. In case of an overtravel of the operating gate 11 the auxiliary restoring element 130 can be slightly elastically deformed.

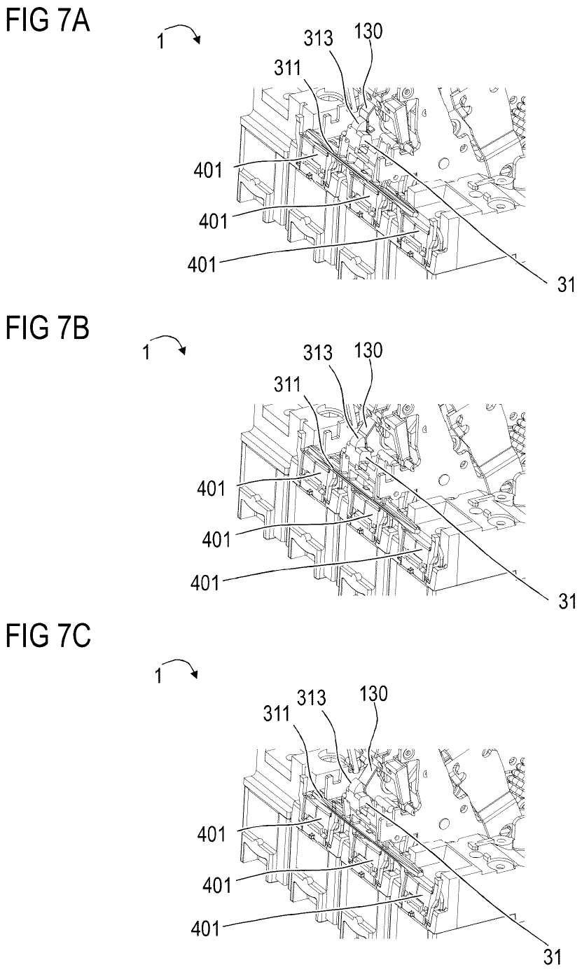

FIGS. 7A to 7C show in three-dimensional views of the movement of the components of the power circuit-breaker 1 as explained above, wherein FIGS. 6A and 6C correspond to the states shown in FIGS. 5 and 6, respectively. FIG. 7B shows the state at a point of time in-between.

As explained above in connection with FIGS. 2A to 2D, the auxiliary restoring element 130 has a contact surface 139 that is configured to directly mechanically interact with the interaction surface 314 of the restoring interaction element 313 by pushing against the interaction surface 314. Additionally, the auxiliary restoring element 130 is configured such that, after the tripping event, during at least a part of the operator-induced change of the actuating mechanism 10 from the tripped position to the first switching position, the contact surface 139 can slide over the interaction surface 314 while at the same time pushing against the interaction surface 314. The sliding of the auxiliary restoring element 130 over the restoring interaction element 313 can also be seen in FIGS. 7A to 7C. The sliding can lower the momentum and force impact of the auxiliary restoring element 130 on the restoring interaction element 313 when interacting with the tripping mechanism 30.

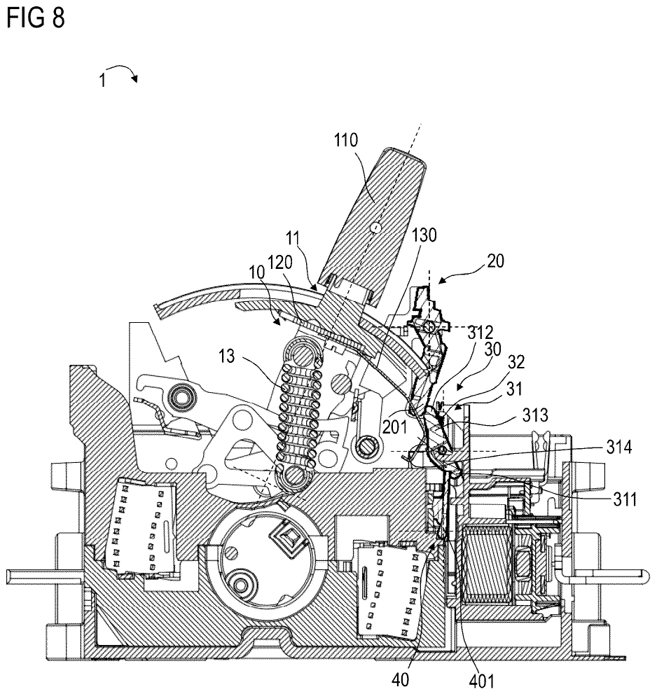

FIG. 8 shows the power circuit-breaker 1 in case of a heavy fault event in which at least one pivoting gate 401 is heavily blocked, for instance jammed, in the tripping state, so that even the additional force exerted by the auxiliary restoring element 130 is not sufficient for moving the at least one pivoting gate 401 and therefore also tripping mechanism 30 into their home positions. The auxiliary restoring element 130 of the actuating mechanism 10 and the restoring interaction element 313 of the tripping mechanism 30 are configured to be in mechanical contact in case when the actuating mechanism 10 is in the first switching position. Since the auxiliary restoring element 130 is a flat spring and, thus, at least partly elastic, the auxiliary restoring element 130 can be deformed and the actuating mechanism 10 can fully return into the first switching position.

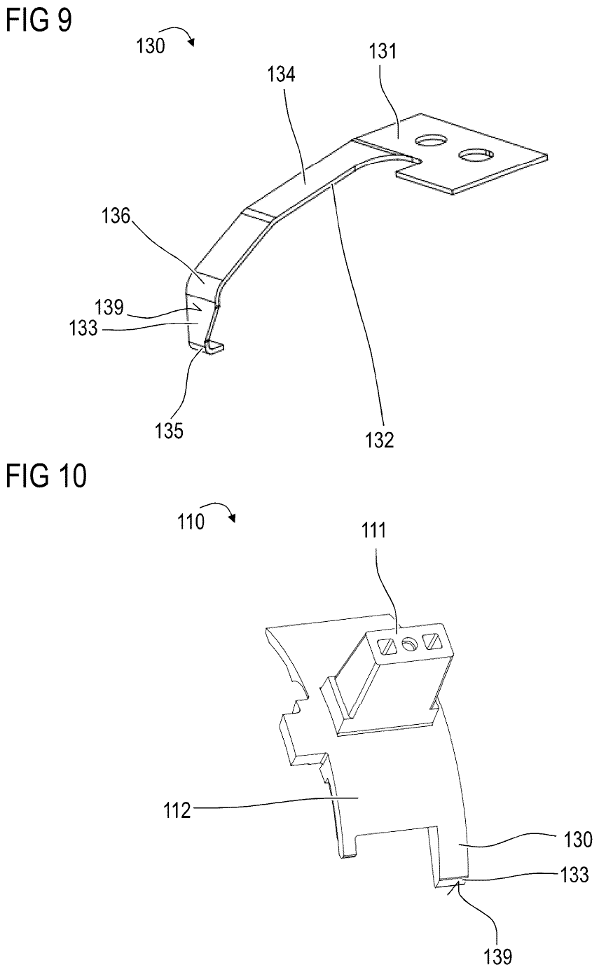

FIG. 9 shows a further embodiment of the auxiliary restoring element 130 that has, in contrast to the embodiment of the auxiliary restoring element shown before, a contact section 133 that has a width that at least partly decreases with increasing distance from the connection section 134. Thus, the contact region 133 becomes narrower towards the end of the auxiliary restoring element 130 that is remote from the operating link. Since the contact region 133 of the auxiliary restoring element 130 can come close to one or more busbars in the power circuit-breaker, a reduced with can increase the distance to at least a part of the busbars.

FIG. 10 shows a further embodiment of the lever element 110 of the operating gate, wherein the auxiliary restoring element 130 is an integral part of the lever element 110. For instance, the auxiliary restoring element 130 can be a nose-shaped extension of the lever element 110. As explained above, the lever element 110 comprises a handle 111 configured for interaction with an operator and a plate element 112 that is configured for being directly fastened to the operating link. The auxiliary restoring element 130 is an integral part of the plate element 112. In other words, the plate element 122 can have a nose-shaped extension that forms the auxiliary restoring element 130. The contact surface 139 of the contact region 133 can be preferably rounded as indicated in FIG. 10.

Alternatively or additionally to the features described in connection with the figures, the embodiments shown in the figures can comprise further features described in the general part of the description. Moreover, features and embodiments of the figures can be combined with each other, even if such combination is not explicitly described.

The presently disclosed subject matter is not restricted by the description on the basis of the exemplary embodiments. Rather, the presently disclosed subject matter encompasses any new feature and also any combination of features, which in particular comprises any combination of features in the patent claims, even if this feature or this combination itself is not explicitly specified in the patent claims or exemplary embodiments.

This patent application claims the priority of German patent application 102023119648.0, the disclosure content of which is hereby incorporated by reference.

### REFERENCE NUMERALS

1 power circuit-breaker
2, 2′ main terminal
3 busbar
4 main contact
5 contact bridge
10 actuating mechanism
11 operating gate
13 spring
20 locking mechanism
30 tripping mechanism
31 tripping bridge
32 return spring
40 tripping unit
90 arc
91 overpressure
110 lever element
111 handle
112 plate element
120 operating link
130 auxiliary restoring element
131 mounting section
132 cantilever section
133 contact section
134 connection section
135 bent section
136 bent section
137 screw
139 contact surface
201 locking mechanism lever
311 tripping rod
312 tripping lever
313 restoring interaction element
314 interaction surface
401 actuating element
410 arc chute
411 channel
F1, F2 force

1. An Actuating mechanism for a power circuit-breaker for opening and closing main contacts of the power circuit-breaker, the actuating mechanism comprising:
an operating gate comprising a lever element and an operating link fastened to each other; and
an auxiliary restoring element that is a part of the operating gate and that is configured for directly mechanically interacting with a restoring interaction element of a tripping mechanism of the power circuit-breaker.

2. The Actuating mechanism according to claim 1, wherein the auxiliary restoring element comprises an elongated part that extends away from operating link.

3. The Actuating mechanism according to claim 1, wherein the auxiliary restoring element is an integral part of the lever element.

4. The Actuating mechanism according to claim 3, wherein the auxiliary restoring element is a nose-shaped extension of the lever element.

5. The Actuating mechanism according to claim 3,
wherein the lever element comprises a handle configured for interaction with an operator and a plate element in direct mechanical contact to the operating link,
wherein the auxiliary restoring element is an integral part of the plate element.

6. The Actuating mechanism according to claim 1, wherein the auxiliary restoring element is a flat spring fixedly connected to the operating link.

7. The Actuating mechanism according to claim 6, wherein the flat spring has a mounting section fastened to the operating link and a cantilever section that extends from the mounting section.

8. The Actuating mechanism according to claim 7,
wherein the cantilever section has a contact section and a connection section between the contact section and the mounting section,
wherein the contact section has at least a first bent section adjacent the connection section.

9. The Actuating mechanism according to claim 8, wherein the contact section has a width that at least partly decreases with increasing distance to the connection section.

10. The Actuating mechanism according to claim 8, wherein the contact section has a second bent section remote from the first bent section, the second bent section forming an end region of the cantilever section.

11. The Actuating mechanism according to claim 6, wherein the lever element and the auxiliary restoring element are fixedly connected to the operating link by means of a screw fastening or rivet fastening.

12. A Power circuit-breaker, comprising:
main contacts;
the actuating mechanism according to claim 1 for opening and closing the main contacts wherein the actuating mechanism has a first switching position in which the main contacts are opened, a second switching position in which the main contacts are closed and a third switching position which is a tripped position after a tripping event has occurred,
a locking mechanism for reversibly locking the actuating mechanism in the second switching position;
a tripping mechanism comprising a tripping bridge with a tripping rod and a restoring interaction element; and
at least one actuating element that is part of a tripping unit and is configured for interacting with the tripping rod;
wherein the at least one actuating element is configured to change from a home position to a tripping position in case of a tripping event,
wherein the at least one actuating element is configured, when a tripping event occurs, to exert a force on the tripping mechanism that causes the tripping mechanism to unlock the locking mechanism, so that the actuating mechanism can change from the second switching position to the tripped position,
wherein the auxiliary restoring element is configured for directly mechanically interacting with the restoring interaction element when, after a tripping event, the actuating mechanism is changed, by an operator, from the tripped position to the first switching position.

13. The Power circuit-breaker according to claim 12, wherein the at least one actuating element is a pivoting gate.

14. The Power circuit-breaker according to claim 12, wherein the tripping unit is a pressure tripping unit and/or an electromagnetic tripping unit.

15. The Power circuit-breaker according to claim 12, wherein the auxiliary restoring element and the restoring interaction element are configured to have no mechanical contact or a weak mechanical contact when, in the absence of a tripping event, the actuating mechanism is in the first switching position.

16. The Power circuit-breaker according to claim 12, wherein the auxiliary restoring element and the restoring interaction element are configured to be in mechanical contact in case of a fault event in which the actuating element is blocked in the tripping state when the actuating mechanism is in the first switching position.

17. The Power circuit-breaker according to claim 12, wherein the auxiliary restoring element has a contact surface that is configured for a direct mechanical interaction with an interaction surface of the restoring interaction element.

18. The Power circuit-breaker according to claim 12, wherein the auxiliary restoring element is configured such that, after a tripping event during at least a part of the change of the actuating mechanism from the second switching position to the first switching position, the auxiliary restoring element pushes against the restoring interaction element.

19. The Power circuit-breaker according to claim 12, wherein the auxiliary restoring element is configured such that, after a tripping event during at least a part of the change of the actuating mechanism from the tripped position to the first switching position, the contact surface slides over the interaction surface.

20. The Power circuit-breaker according to claim 12, wherein the tripping mechanism is configured for exerting a force on the at least one actuating element to push the at least one actuating element towards the home position of the at least one actuating element.
